(19) United States
(12) Patent Application Publication
(10) Pub. No.: US 2007/0019606 A1
(43) Pub. Date: Jan. 25, 2007

(54) Wireless communication device and wireless communication method

(76) Inventor: Hisayuki Watanabe, Iwaki-city (JP)

Correspondence Address: BRINKS HOFER GILSON & LIONE, P.O. BOX 10395, CHICAGO, IL, 60610, US

(21) Appl. No.: 11/483,148

(22) Filed: Jul. 7, 2006

(30) Foreign Application Priority Data
Jul. 11, 2005 (JP) 2005-201405

(51) Int. Cl. H04B 7/212

(52) U.S. Cl. 370/347

(57) ABSTRACT

A wireless communication device and a wireless communication method are provided to reduce the wasting of a battery by shortening a time-out interval defined when power is supplied from a battery to perform communication. The wireless communication device is adapted to make a request for predetermined information when the information is not received from the other party of communication before a set time Tₛ has elapsed, and to terminate the communication if the information is not received even after a set number of requests. The wireless communication device includes a wireless communication unit for wirelessly communicating with an external device, a power supply source detector for detecting whether electric power is supplied from a power source other than the battery, or from the battery, and a communication processor for setting a time-out interval defined by the set time and the set number when power is supplied from the battery to be shorter than a time-out interval defined when power is supplied from a power source other than the battery.

### BACKGROUND OF THE INVENTION

1. Field of the Invention

The invention relates to a wireless communication device and a wireless communication method. In particular, the invention is directed to a wireless communication device which is adapted to make a request for predetermined information when the information is not received from the other communication party before a set time interval Tₛ has elapsed, and to terminate communication if the information is not received after a set number Nₛ of requests, and to a wireless communication method using the same.

2. Description of the Related Art

Vehicle-mounted devices have an intelligent function, as well as a handsfree function (vehicle telephone function), a navigation function, an audio function, a wireless LAN communication function, and the like. According to the handsfree function, a user can call another party or person in a handsfree manner by connecting the user's cellular phone to a telephone of the other party through a wireless base station and a public telephone network when the user calls from inside a vehicle by manipulating an operating key for the vehicle-mounted device, and can receive a phone call from the other party in a handsfree manner in response to an incoming call from an external telephone. As shown in FIG. 11, the vehicle-mounted device 1 may have a function of communicating with a home personal computer 3 through an access point 2 using a built-in wireless LAN communication unit. Alternatively, the vehicle-mounted device 1 may have a function of perusing the contents of Web pages from a Web site through the connection to the Internet 4 through the wireless LAN communication unit and the access point 2 using an Internet browser in the same way as described above. Or the vehicle-mounted device 1 may have a function of transmitting and receiving electronic mail through the Internet. The relationship between the vehicle-mounted device and the Web server, or between the vehicle-mounted device and the home personal computer, corresponds to the relationship between the client and the server, wherein the communication therebetween is performed in accordance with a sequence as shown in FIG. 12.

FIG. 12 illustrates the sequence from when the connection by a transmission control protocol (TCP) is established, to when the communication is terminated, thereby finishing the connection. Before the establishment of the connection, the client is in a closed state, and the server is waiting for a request for connection. In such a state, when a communication command occurs, a synchronous bit (SYN bit) and an ACK are transmitted and received between the client and the server. Then, when the connection is established, the communication is carried out between the client and the server. In order to release the connection after the communication, a FIN packet with a finish bit (FIN bit), and the ACK are transmitted and received between the client and the server. Thus, the client returns to the closed state, and the server returns to the waiting state.

In the communication between the two parties (between the client and the server), the client may transmit a request for predetermined information to the server, for example, downloading of a file. If the file is not received before a set time interval Tₛ, has elapsed, the downloading is requested again. If the downloading of the desired file is not completed even after a set number Nₛ, of requests, the communication is terminated (time-out). That is, the normal communication cannot be carried out depending on the communication environment, a load condition of the terminals, and a load condition of the server, and if the required file is not received even after the predetermined number of requests, the communication is terminated. A time interval defined by the set time interval Tₛ and the set number Nₛ (=Tₛ×Nₛ) is hereinafter referred to as a time-out interval.

In communication applications in which the vehicle-mounted device has a communication function, such as that of a wireless LAN, and the communication is maintained by a battery of the vehicle when the engine is stopped, when a time-out for the communication occurs, there arises a problem that the wireless LAN wastes the battery during the time-out interval. FIG. 13 explains the consumption of the battery during the time-out interval in a case where ten musical pieces are intended to be downloaded from the home personal computer 3 by the vehicle-mounted device 1 every day, provided that the engine has stopped for one week. In the example, the time interval for wireless communication using the battery is one hour (=3,600 seconds), which is designated as the time-out interval. On the first day, the condition of the radio signal is bad, and thus the downloading of 10 pieces takes 3,600 seconds. That is, wireless communication is impossible by using the battery anymore, and the downloading of music becomes impossible starting from the second day regardless of whether the radio signal condition is good or not, resulting in only ten pieces of music downloaded in one week. In short, although the number of musical pieces downloaded is small, the vehicle-mounted device may drain the battery. This creates a problem that during this interval, other processing to be performed until the battery is charged, for example, an internet communication, or a mail communication, cannot be carried out.

A technique for variably controlling the time-out interval based on the quality of wireless communication has been proposed in, for example, Japanese Patent Laid-Open No. 2000-261496. Another technique for updating the time-out interval based on statistical information, including a starting time of the time-out interval, has also been proposed in, for example, Japanese Patent Laid-Open No. H05(1993)-122275.

The above-mentioned prior techniques are adapted to control the time-out interval in view of the wireless communication quality or the statistical data of the past time-out starting times, but not to solve the problem of battery consumption in the communication applications that maintain the communication by using the battery.

### SUMMARY OF THE INVENTION

It is an object of the invention to reduce the battery use by shortening the time-out interval defined when the power is supplied from the battery to perform the communication.

It is another object of the invention to reduce the battery use by variably controlling the time-out interval depending on the communication environment when the power is supplied from the battery to perform the communication, and thereby complete the most desired communication possible.

According to the invention, the above-mentioned objects are achieved by a wireless communication device and a wireless communication method which are adapted to make a request for predetermined information when the information is not received from the other party of a communication before a set time interval Tₛ has elapsed, and to terminate communication if the information is not received even after a set number Nₛ, of the requests.

In one aspect of the invention, the wireless communication method comprises the steps of determining whether electric power is supplied from a power source other than a battery, or from the battery, and setting a time-out interval defined by the set time and the set number when the power is supplied from the battery to be shorter than a time-out interval defined when the power is supplied from a power source other than the battery. In another aspect of the invention, the wireless communication method further comprises the steps of judging a communication environment, and variably controlling the time-out interval based on the communication environment. In this case, (1) the set number is changed to control the time-out interval, or (2) the set time is changed to control the time-out interval, or (3) the set number and the set time are changed to control the time-out interval.

If the wireless communication device is a vehicle-mounted device, the battery is a battery of a vehicle, and a power source other than the battery can be a generator of the vehicle for generating electric power by rotation of the engine. The method further comprises determining whether power is supplied from the generator or from the battery based on the rotation of the engine.

If the wireless communication device is a portable communication terminal incorporating a battery, the power source other than the battery can be a commercial power source, and it is determined whether or not power is supplied from the commercial power source based on the presence or absence of an output from a commercial power supply circuit.

In a further aspect of the invention, the wireless communication device includes a wireless communication unit for wirelessly communicating with an external device, a power supply source detector for detecting whether electric power is supplied from a power source other than a battery, or from the battery, and a communication processor for setting a time-out interval defined by the set time and the set number when the power is supplied from the battery to be shorter than a time-out interval defined when the power is supplied from the power source other than the battery. The wireless communication device of the invention further includes a communication environment detector for detecting a communication environment, and the communication processor variably controls the time-out interval based on the detected communication environment.

According to the invention, it is determined whether power is supplied from a power source other than the battery or from the battery. When power is supplied from the battery, the time-out interval defined by the set time and the set number is set to be shorter than the time-out interval defined when power is supplied from a power source other than the battery. Thus, the time-out interval defined when power is supplied from the battery to perform the communication is shortened, so that the wasting of the battery can be reduced.

Furthermore, according to the invention, the communication environment is judged, and based on the communication environment, the time-out interval is variably controlled, thereby reducing the wasting of the battery, and completing the most desired communication possible.

### BRIEF DESCRIPTION OF THE DRAWING

FIG. 1 is a diagram showing a configuration of a communication system to which the invention can be applied;

FIG. 2 is a schematic diagram of a mechanism for supplying power to a vehicle;

FIG. 3 is a schematic diagram of a vehicle-mounted device according to one embodiment of the invention;

FIG. 4 is a flowchart of switching processing of a time-out interval performed by the vehicle-mounted device controller;

FIG. 5 is a flowchart of time-out processing performed by the vehicle-mounted device controller;

FIG. 6 is a diagram explaining the consumption of the battery according to the embodiment when the vehicle-mounted device downloads ten musical pieces from a home personal computer every day, provided that the engine has stopped for one week;

FIG. 7 is a diagram of a communication system according to a second embodiment;

FIG. 8 is a flowchart of switching processing of the time-out interval performed by the vehicle-mounted device controller;

FIG. 9 is a diagram of a communication system including a notebook computer;

FIG. 10 is a flowchart of switching processing of the time-out interval performed by the notebook computer;

FIG. 11 is a diagram of a communication system;

FIG. 12 is a sequence from when a connection by a transmission control protocol (TCP) is established to when a communication is terminated; and

FIG. 13 is a diagram explaining the conventional consumption of the battery during the time-out interval in a case where ten musical pieces are intended to be downloaded from a home personal computer by the vehicle-mounted device every day, provided that the engine has stopped for one week.

### DESCRIPTION OF THE PREFERRED EMBODIMENTS

The invention is directed to a wireless communication device adapted to make a request for predetermined information when the information is not received from the other communication party before a set time Tₛ, has elapsed, and to terminate the communication if the information is not received after a set number Nₛ, of the requests. The wireless communication device includes a wireless communication unit for wirelessly communicating with an external device, a power supply source detector for detecting whether electric power is supplied from a power source other than a battery, or from the battery, a communication processor for setting a time-out interval defined by the set time and the set number when power is supplied from the battery to be shorter than a time-out interval defined when power is supplied from a power source other than the battery, and a communication environment detector for detecting a communication environment. The communication processor variably controls the time-out interval based on the detected communication environment.

First Embodiment

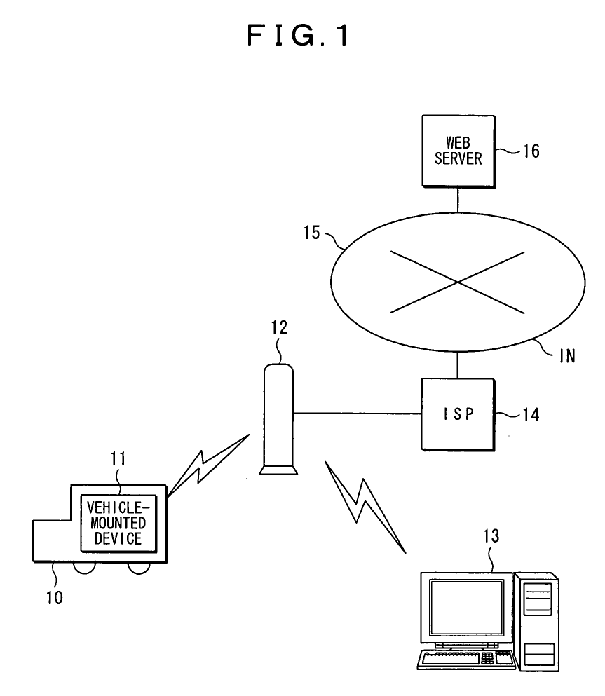

FIG. 1 is a diagram of a communication system to which the invention can be applied. As shown in the figure, a vehicle-mounted device 11 mounted in a vehicle 10 has a function of communicating with, e.g., a home personal computer 13 through a built-in wireless LAN communication unit and a wireless LAN access point 12. Alternatively or additionally, the vehicle-mounted device 11 may have a function of communicating with an ISP (Internet Service Provider) 14 through the wireless LAN communication unit and the wireless LAN access point 12 using an internet browser in the same way, thereby perusing Web pages from a Web server 16 through the Internet (IN) 15. Alternatively or additionally, the vehicle-mounted device 11 may have a function of transmitting electronic mail through the Internet.

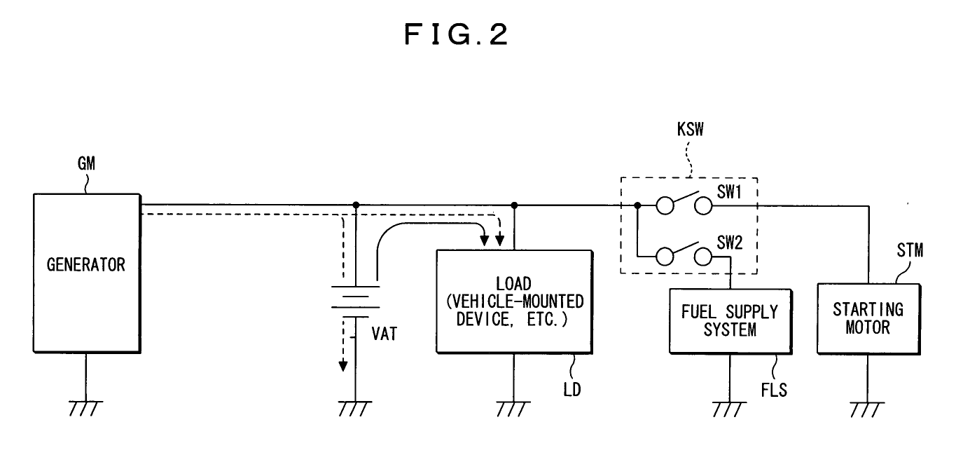

FIG. 2 shows a configuration of a mechanism for supplying power to the vehicle. A battery VAT of the vehicle is adapted to supply electric power to the vehicle-mounted device and other loads LD when the vehicle is stopped, while supplying power to a fuel supply system FLS, and a starting motor STM through a key switch KSW to energize them. Once a key of the vehicle is inserted into a key hole and rotated to a starting position when the vehicle is stopped, the switches SW1 and SW2 are turned on to supply fuel to the engine, and the starting motor STM rotates, causing the engine to rotate. Then, when the key is returned to a traveling position, the switch (ignition switch) SW1 is turned off while the on state of the switch SW2 is maintained. Thus, fuel continues to be supplied to the engine, so that the rotation of the engine is maintained. The rotation of the engine causes the generator GM to rotate to generate direct current power through a rectifier (not shown), thereby charging the battery VAT while supplying power to the load LD and the fuel supply system FLS or the like. After the vehicle is stopped and the key is returned to an engine stopping position, the switch SW2 is turned off to stop the supply of fuel to the engine, so that the rotation of the engine is stopped, and the generation of electric power by the generator GM is also terminated. From then on, power is supplied from the battery VAT to the load LD. As mentioned above, while the engine rotates, electric power is supplied from the generator GM to the load LD, whereas, when the engine is stopped, power is supplied from the battery VAT to the load LD.

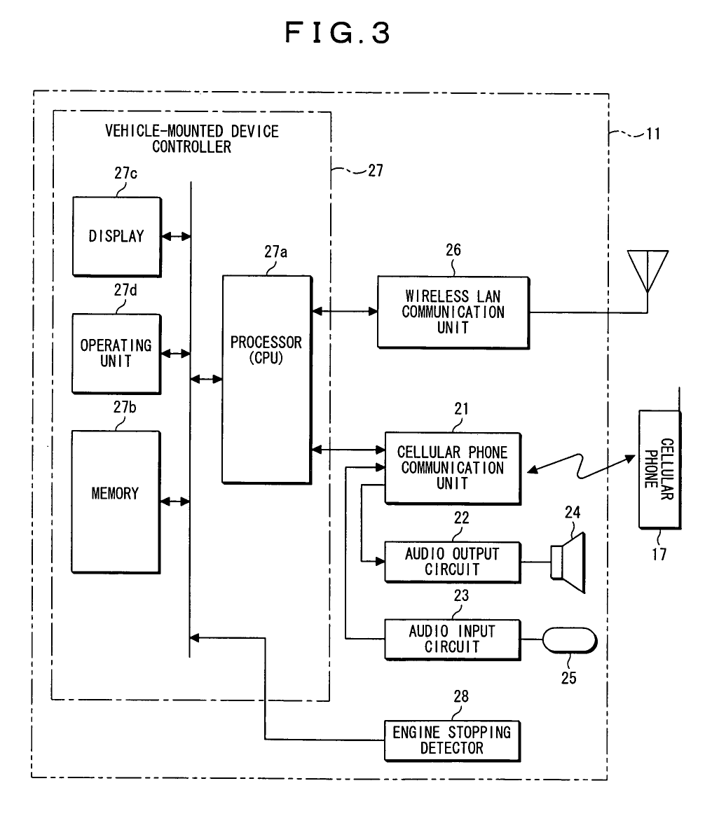

FIG. 3 illustrates a configuration of the vehicle-mounted device according to one embodiment of the invention. A cellular phone communication unit 21 of the vehicle-mounted device 11 is connected to a cellular phone 17 via Bluetooth, so that the vehicle-mounted device 11 can call another party's device through the cellular phone 17, a base station (BS), and a general communication network in a handsfree manner. Note that the vehicle-mounted device 11 includes an audio output circuit 22 and an audio input circuit 23 so as to achieve the handsfree function. The audio output circuit 22 receives an audio signal supplied by the cellular phone 17, from the cellular phone communication unit 21 to produce audio from a speaker 24. The audio input circuit 23 sends an audio signal supplied by the microphone 25 to the cellular phone 17 through the cellular phone communication unit 21, and the cellular phone transmits the audio signal from an antenna into space.

A wireless LAN communication unit 26 of the vehicle-mounted device 11 accesses the wireless LAN access point 12 (see FIG. 1) to communicate with the home personal computer 13, or connects to the Internet 15 to download and peruse Web pages from the Web server 16, or transmits and receives electronic mail through the Internet.

A vehicle-mounted device controller 27 has the same intelligent function as that of the personal computer, the communication function by the wireless LAN, the Internet communication function, the handsfree phone function, and the like. The vehicle-mounted device controller 27 includes a processor (CPU) 27a, a memory 27b for storing therein a downloaded file and a processed result, such as electronic mail, a display 27c for displaying the processed result, the downloaded file, and a menu, and an operating unit 27d for performing a communication operation and a telephone operation. Furthermore, the vehicle-mounted device controller 27 acquires a rotation signal and a stopping signal of the engine from an engine stopping detector 28, and determines whether the vehicle-mounted device is presently being supplied with electric power from the generator GM (see FIG. 2) or from the battery VAT. Based on this determination, the controller switches between the time-out intervals.

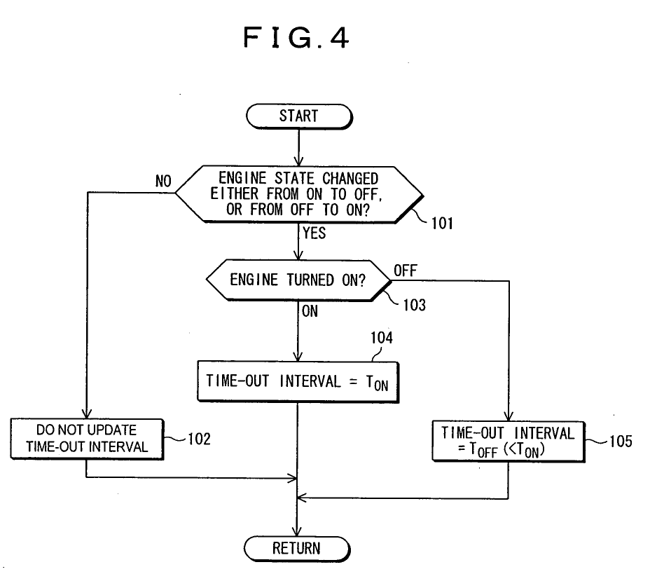

FIG. 4 is a flowchart of processing for switching between the time-out intervals of the vehicle-mounted device controller 27.

The processor 27amonitors whether the state of the engine has changed either from on to off or from off to on by monitoring a signal from the engine stopping detector 28 (step 101). If the engine state has not changed, the time-out interval is not updated (step 102). Once the engine state is changed, it is determined whether or not the engine is rotating (in an on state) (step 103). When the engine is rotating, the time-out interval is set as Tₒₙ (step 104). When the engine is stopped (in an off state), the time-out interval is set as T_{off} (step 105). In this case, the time-out interval when power is supplied from the battery is shortened to satisfy the relationship of: T_{off} <Tₒₙ. Thus, even if the communication environment is bad and thus the desired file cannot be received, the communication is terminated when the time-out interval T_{off} has elapsed, thereby reducing the draining of the battery.

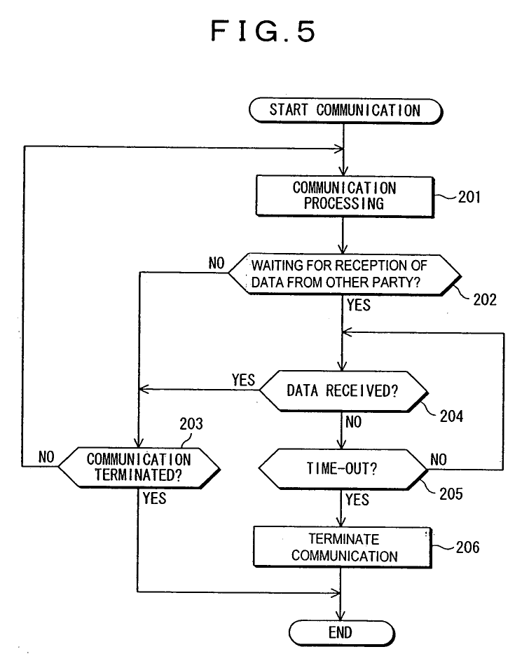

FIG. 5 is a flowchart of time-out processing performed by the vehicle-mounted device controller 27.

A connection is established between the vehicle-mounted device 11 (see FIG. 1) and the home personal computer 13, whereby communication is carried out (step 201). The vehicle-mounted device controller 27 checks whether or not the vehicle-mounted device 11 is waiting for reception of data from the home personal computer 13, for example, downloading of a file such as music (step 202). If it is not waiting for the data, the controller checks whether the communication is terminated or not (step 203). If the communication is terminated, the processing is terminated. If the communication is not terminated, processing returns to the start, and the following processing will be repeatedly carried out.

On the other hand, if the device is waiting for data at step 202, it is checked whether the data is received or not, for example, whether the downloading of the file is completed or not (step 204). If the reception of the data is completed, the processing at step 203 is carried out. However, if the reception of data is not terminated at step 204, it is checked whether the time-out interval has elapsed or not (step 205). If the time-out interval has not elapsed yet, the processing following step 204 is repeatedly carried out to wait for the reception of the data. If the time-out interval has elapsed, the communication with the home personal computer 13 is terminated (step 206).

As mentioned above, in a case where the data cannot be received due to the deterioration of the communication environment and the congestion of communication, if the time-out interval T_{off} has elapsed, the communication is terminated. Thus, wasting of the battery due to continuously waiting for the reception of data can be reduced.

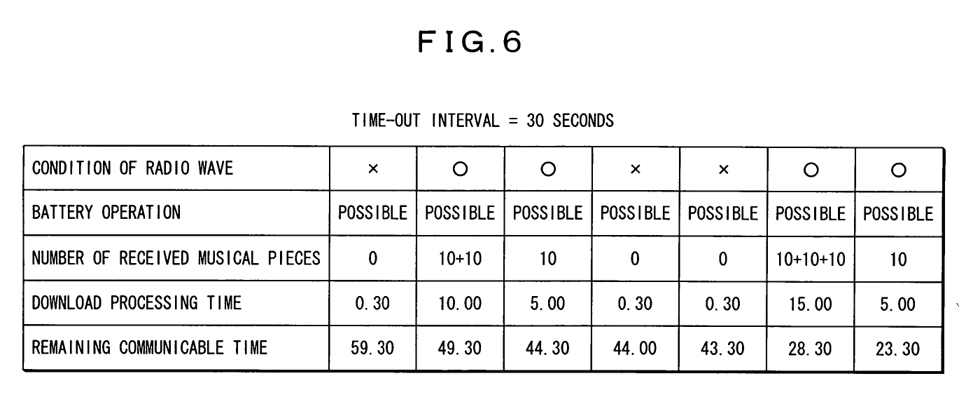

FIG. 6 is a diagram explaining the consumption of the battery according to the embodiment, when the vehicle-mounted device 11 downloads ten musical pieces from the home personal computer 13 every day, provided that the engine has been stopped for one week. It is assumed that the time during which wireless communication powered by the battery is available is one hour, the time-out interval while power is supplied from the battery is 30 seconds, and the time for downloading ten musical pieces when the condition of the radio signal is good is five minutes. On the first day, the condition of the radio signal is bad, and the time-out interval has elapsed before downloading, resulting in a remaining time of the battery of 59 minutes 30 seconds. On the second day, the condition of the radio signal is good, and the downloading of twenty musical pieces including the musical pieces for the previous day in total is completed, taking 10 minutes, resulting in a remaining time of the battery of 49 minutes 30 seconds. On the third day, the condition of the radio signal is good, and the downloading of ten musical pieces is completed, taking five minutes, resulting in a remaining time of the battery of 44 minutes 30 seconds. On the fourth day, the condition of the radio signal is bad, and the time-out interval has elapsed before downloading, resulting in a remaining time of the battery of 44 minutes 00 seconds. On the fifth day, the condition of the radio signal is bad, and the time-out interval has elapsed before downloading, resulting in a remaining time of the battery of 43 minutes 30 seconds. On the sixth day, the condition of the radio signal is good, and the downloading of thirty musical pieces including the musical pieces for the day before the previous day, and for the previous day in total is completed, taking 15 minutes, resulting in a remaining time of the battery of 28 minutes 30 seconds. On the seventh day, the condition of the radio signal is good, and the downloading of ten musical pieces is completed, taking five minutes, resulting in a remaining time of the battery of 23 minutes 30 seconds. As mentioned above, according to the embodiment, the downloading of seventy musical pieces is completed, resulting in a remaining time of the battery of 23 minutes 30 seconds, thus enabling other communication processing.

Second Embodiment

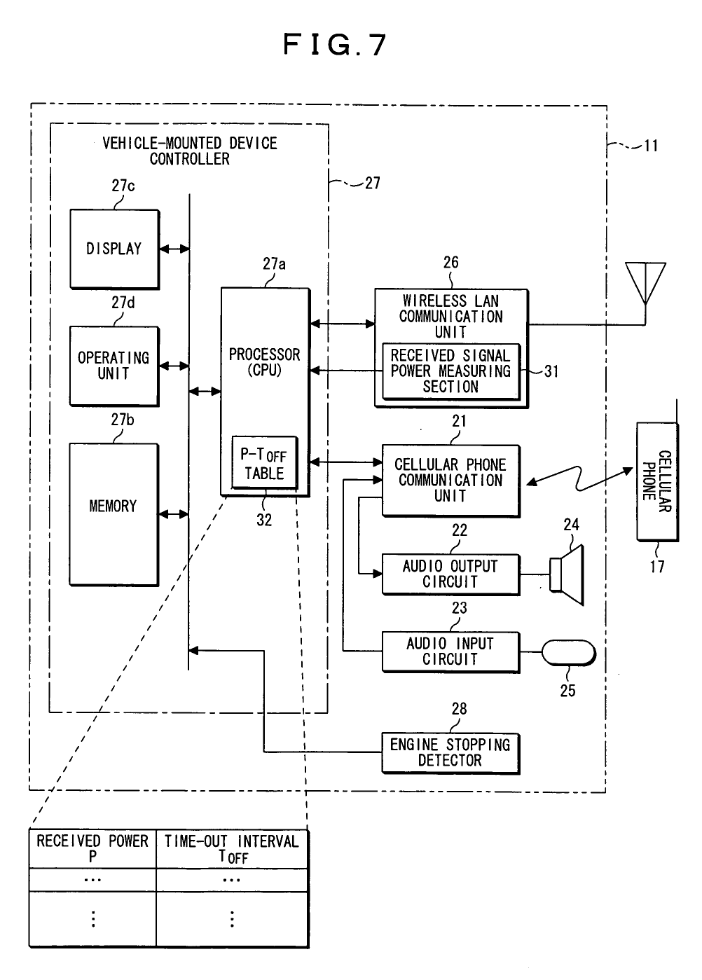

FIG. 7 is a diagram of a communication system according to the second embodiment, wherein elements that are common to the first embodiment of FIG. 3 are given the same reference numerals. The differences from FIG. 3 are that a received signal power measuring section 31 is provided within the wireless LAN communication unit 26 for measuring the power of a received signal so as to measure an environment of the wireless communication, and that the processor 27a of the vehicle-mounted device controller 27 includes a relation table 32 between a received power P and a time-out interval T_{off} to variably control the time-out interval T_{off} based on the actual received power. The relationship between the received power P and the time-out interval T_{off} is previously set in the table 32. Note that the smaller the received power and the worse the communication environment, the shorter the time-out interval is established. The larger the received power and the better the communication environment, the longer the time-out interval T_{off} is established, and the maximum value T_{off} (max) is equal to Tₒₙ. In order to variably control the time-out interval T_{off}, the following operations will be carried out: (1) the set number Nₛ is changed to control the time-out interval, or (2) the set time Tₛ is changed to control the time-out interval, or (3) the set number Nₛ and the set time Tₛ are both changed to control the time-out interval.

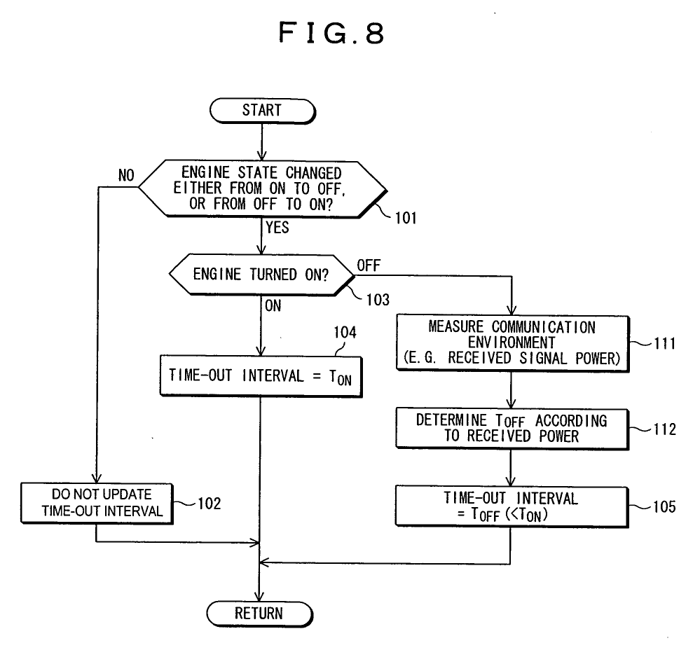

FIG. 8 is a flowchart of switching processing of the time-out interval performed by the vehicle-mounted device controller 27 in the second embodiment, in which steps 101 to 105 are the same as those of FIG. 4.

The processor 27a monitors whether the engine state has changed either from on to off, or from off to on by monitoring a signal from the engine stopping detector 28 (step 101). If the engine state has not changed, the time-out interval is not updated (step 102). Once the engine state has changed, it is checked whether or not the engine is rotating (in an on state) (step 103). When the engine is rotating, the time-out interval is set as Tₒₙ (step 104). When the engine is stopped (turned off), the communication environment (received signal power) is measured (step 111). The time corresponding to the received signal power is determined from the table 32 (step 112), and then is set as the time-out interval T_{off} (step 105).

Note that the flowchart of the time-out processing according to the second embodiment is basically the same as that of the first embodiment in FIG. 5. As mentioned above, according to the second embodiment, the communication environment is judged, and based on the communication environment, the time-out interval is variably controlled, thereby reducing the wasting of the battery, and completing the most desired communication possible.

Third Embodiment

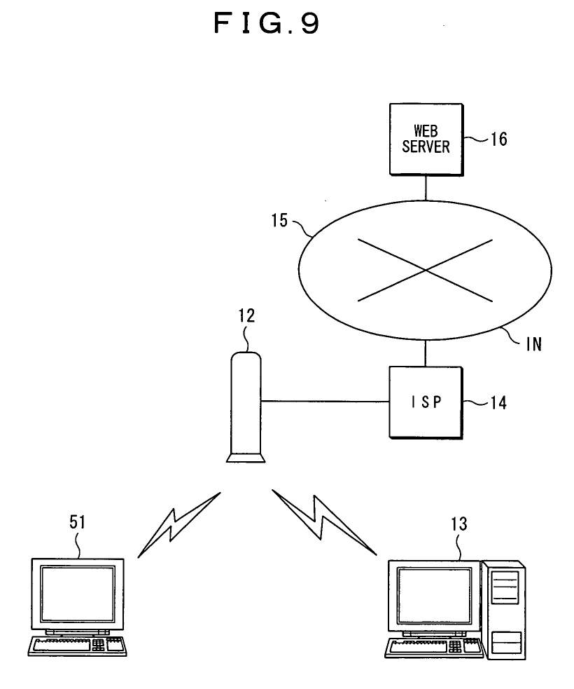

Although in the above embodiments, the invention is applied to the communication of a vehicle-mounted device, the invention is not limited thereto. The invention can be applied to a portable communication terminal, such as a notebook computer, to which power is appropriately supplied from a commercial power source and a built-in battery. FIG. 9 is a diagram of a communication system including a notebook computer, wherein elements that are common to the communication system in FIG. 1 are given the same reference numerals. The difference from FIG. 1 is that a notebook computer 51 is provided instead of the vehicle-mounted device 11.

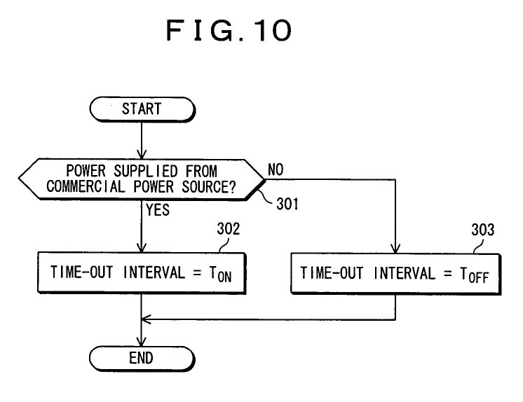

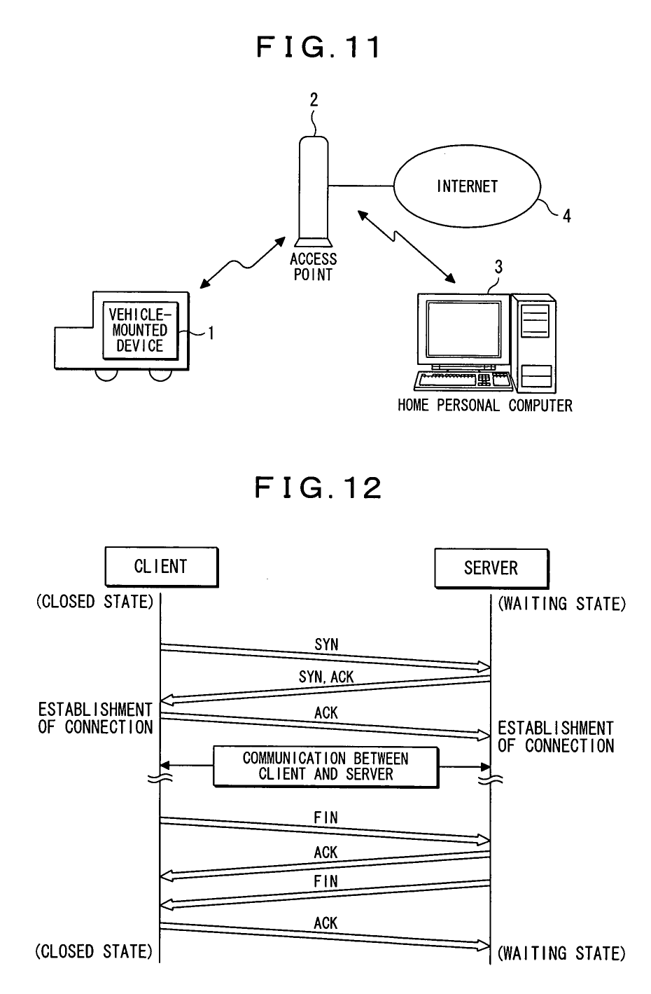

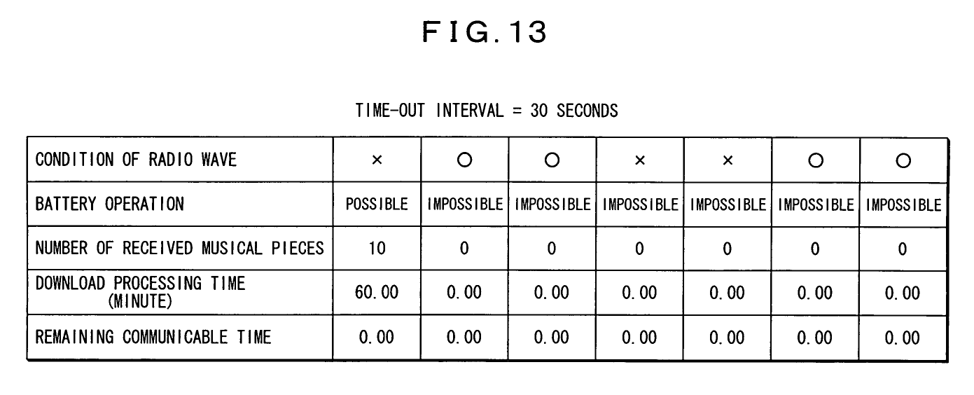

FIG. 10 is a flowchart of switching processing between the time-out intervals of the notebook computer. A processor of the notebook computer 51 checks whether or not electric power is supplied from the commercial power source (step 301). If power is supplied from the commercial power source, the time-out interval is set as Tₒₙ (step 302). If power is not supplied from the commercial power source, that is, if power is supplied from the battery, the time-out interval is set as T_{off} (step 303). Note that the flowchart of the time-out processing according to the third embodiment is basically the same as that of FIG. 5 according to the first embodiment. Whether or not power is supplied from the commercial power source can be detected based on the presence or absence of an output from the power supply circuit incorporated in the personal computer.

As can be seen from the above description, by shortening the time-out interval T_{off} to satisfy the relationship of: T_{off} <Tₒₙ when power is supplied from the battery, the communication can be terminated when the time-out interval T_{off}has elapsed under a bad communication environment, thereby reducing the wasting of the battery.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

1. A wireless communication method in a wireless communication device which is adapted to make a request for predetermined information when the information is not received from another party of communication before a set time Tₛ has elapsed, and to terminate the communication if the information is not received after a set number Nₛ of the requests, the method comprising:
determining whether electric power is supplied from a power source other than the battery, or from the battery; and
setting a time-out interval defined by the set time and the set number when power is supplied from the battery to be shorter than a time-out interval defined when power is supplied from a power source other than the battery.

2. The wireless communication method according to claim 1, further comprising:
judging a communication environment; and
variably controlling the time-out interval based on the judged communication environment.

3. The wireless communication method according to claim 2, further comprising controlling the time-out interval by changing the set number.

4. The wireless communication method according to claim 2, further comprising controlling the time-out interval by changing the set time.

5. The wireless communication method according to claim 2, further comprising controlling the time-out interval by changing the set number and the set time.

6. The wireless communication method according to claim 1, wherein the wireless communication device is a vehicle-mounted device, the battery is a battery of the vehicle, and a power source other than the battery is a generator of the vehicle for generating electric power by rotation of an engine.

7. The wireless communication method according to claim 6, further comprising determining whether power is supplied from the generator or from the battery based on the rotation of the engine.

8. The wireless communication method according to claim 1, wherein the wireless communication device is a portable communication terminal incorporating the battery, and the power source other than the battery is a commercial power source.

9. A wireless communication device adapted to make a request for predetermined information when the information is not received from another party of communication before a set time Tₛ has elapsed, and to terminate the communication if the information is not received after a set number Nₛ of the requests, the device comprising:
a wireless communication unit for wirelessly communicating with an external device;
a power supply source detector for detecting whether electric power is supplied from a power source other than a battery, or from the battery; and
a communication processor for setting a time-out interval defined by the set time and the set number when power is supplied from the battery to be shorter than a time-out interval defined when power is supplied from a power source other than the battery.

10. The wireless communication device according to claim 9, further comprising a communication environment detector for detecting a communication environment,
wherein the communication processor variably controls the time-out interval based on the communication environment detected.

11. The wireless communication device according to claim 10, wherein the communication processor controls the time-out interval by changing the set number.

12. The wireless communication device according to claim 10, wherein the communication processor controls the time-out interval by changing the set time.

13. The wireless communication device according to claim 10, wherein the communication processor controls the time-out interval by changing the set number and the set time.

14. The wireless communication device according to claim 9, wherein the wireless communication device is a vehicle-mounted device, the battery is a battery of the vehicle, and the power source other than the battery is a generator of the vehicle for generating electric power by rotation of an engine.

15. The wireless communication device according to claim 14, wherein the power supply source detector detects whether power is supplied from the generator or from the battery based on the rotation of the engine.

16. The wireless communication device according to claim 9, wherein the wireless communication device is a portable communication terminal incorporating the battery, and the power source other than the battery is a commercial power source.

17. A wireless communication method in a wireless communication device which is adapted to make a request for predetermined information from another party of communication, and to terminate the communication if the information is not received after a set time-out interval, the method comprising:
determining whether electric power is supplied from a power source other than the battery, or from the battery; and
setting a time-out interval when power is supplied from the battery to be shorter than a time-out interval when power is supplied from a power source other than the battery.

18. The wireless communication method according to claim 17, further comprising:
judging a communication environment; and
variably controlling the time-out interval based on the judged communication environment.

19. The wireless communication method according to claim 17, wherein the wireless communication device is adapted to make a request for predetermined information when the information is not received from the other party of communication before a set time Tₛ has elapsed, and to terminate the communication if the information is not received after a set number Nₛ of the requests, thereby defining a time-out interval Tₛ×Nₛ, the method further comprising controlling the time-out interval by changing at least one of the set number and the set time.

20. The wireless communication method according to claim 17, wherein the wireless communication device is a portable communication terminal incorporating the battery, and the power source other than the battery is a commercial power source.
